(19) United States
(12) Patent Application Publication
(10) Pub. No.: US 2019/0125127 A1
(43) Pub. Date: May 2, 2019

(54) SPIT ROASTER FOR FOODS

(71) Applicant: Jose Maria SANCHEZ ANTON, Logrono La Rioja (ES)

(72) Inventor: Jose Maria SANCHEZ ANTON, Logrono La Rioja (ES)

(21) Appl. No.: 16/165,581

(22) Filed: Oct. 19, 2018

(30) Foreign Application Priority Data
Oct. 30, 2017 (ES) U 201731316

(51) Int. Cl. A47J 37/04

(52) U.S. Cl. CPC A47J 37/041

(57) ABSTRACT

The present invention relates to a spit roaster for foods comprising spits and at least two supports, each of the supports having two vertical profiles with feet for supporting the support and horizontal profiles which are arranged joining the two vertical profiles to one another, and spaced from one another, determining different roasting heights, and where the spits can be arranged such that they are freely supported on the horizontal profiles of each of the supports, the spits being configured for holding foods.

### CROSS REFERENCE TO RELATED APPLICATION

This application claims priority of Spanish Application No. U 201731316 filed Oct. 30, 2017, application which is incorporated herein by reference.

### FIELD OF THE ART

The present invention relates to devices used for roasting foods, proposing a spit roaster having a simplified structural configuration which allows regulating the height at which foods are arranged, and adapting same to the place where hot coals for roasting are found, such as fireplaces, ovens, barbecues, or the like.

### STATE OF THE ART

Metal spit roasters or barbecues with a grill are known today. These spit roasters are intended for use with firewood and/or coal combustion for which they include an air inlet on a lower part thereof. In order to regulate the airflow going through the air inlet, and thereby the heat given off by the corresponding hot coals, said air inlet can be regulated to enable more or less air to pass through same.

In the use of conventional spit roasters, however, combustion, most often with flames, occurs when a fat-containing food, meat, or fish, is placed in spit roasters and a few drops of this fat drip onto said flames, causing the roasted food to have an unpleasant taste, being smoked and even getting burnt. This effect is extremely difficult and sometimes even impossible to control by means of regulating the air inlet.

On the other hand, if said spit roasters have a metal griddle for depositing foods to be roasted thereon, the described problem derived from the fat dripping onto the hot coals is solved as the griddle prevents the fat from falling onto said hot coals. However, this is not desirable because it entails roasting the foods on the griddle instead of a grill.

Additionally, conventional spit roasters are usually made up of large and fixed installations which limit their use.

In view of the described drawbacks or limitations of the solutions existing today, a solution which allows roasting on the grill and offers flexibility both in spit roaster arrangement and in regulating the distance between the hot coals and the foods, is required.

### OBJECT OF THE INVENTION

In order to achieve this objective and solve the technical problem described up until now, in addition to provide additional advantages that can be derived hereinbelow, the present invention provides a spit roaster for foods comprising spits and at least two supports, each of the supports having two vertical profiles with feet for supporting the support and horizontal profiles. The horizontal profiles are arranged joining the two vertical profiles to one another, and spaced from one another, determining different roasting heights. The spits can be arranged such that they are freely supported on the horizontal profiles of each of the supports, the spits being configured for holding foods.

A spit roaster for foods that can be moved and placed according to different spaces for placement thereof is thereby provided. Additionally, the spit roaster for foods provides different roasting heights, which allows roasting foods, be they fish or meat, with different intensities, or simply keeping them warm once roasted.

The spits have an angled, inverted V shape. Therefore, it is preferable for the spits to be supported on the horizontal profiles, limiting the possibility of being moved undesirably while roasting. Likewise, said angled, inverted V shape provides a higher degree of rigidity to the spits to withstand a higher food weight and improves their heat deformation resistance.

According to the foregoing, the spits are configured for foods to be held directly thereon or through a food support in which the foods to be roasted can be arranged. Therefore, the food support can be a grill, a fish pan, or fish-shaped grill, etc.

The two vertical profiles and the horizontal profiles of each of the supports have an angled L shape. It should be an angle having the same dimensions on its sides. The supports are preferably identical to one another. The spit roaster for foods can thereby be manufactured in a simple and cost-effective manner while having a sturdy structure at the same time. Other types of profile can also be used: flat, tubes, etc.

Optionally, the supports comprised in the spit roaster for foods are three in number. An additional support is thereby provided for the spits.

### DESCRIPTION OF THE DRAWINGS

FIG. 1 shows a perspective view of a spit roaster for foods object of the invention according to an embodiment.

FIG. 2 shows an elevational view of a support comprised in the spit roaster for foods object of the invention.

FIG. 3 shows a plan view of the support comprised in the spit roaster for foods object of the invention shown in FIG. 2.

FIG. 4 shows a side view of the support comprised in the spit roaster for foods object of the invention shown in FIG. 2.

FIG. 5 shows a perspective view of the spit roaster for foods object of the invention according to another embodiment.

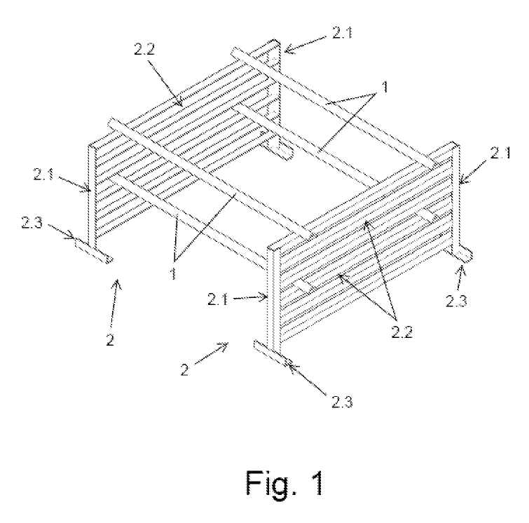

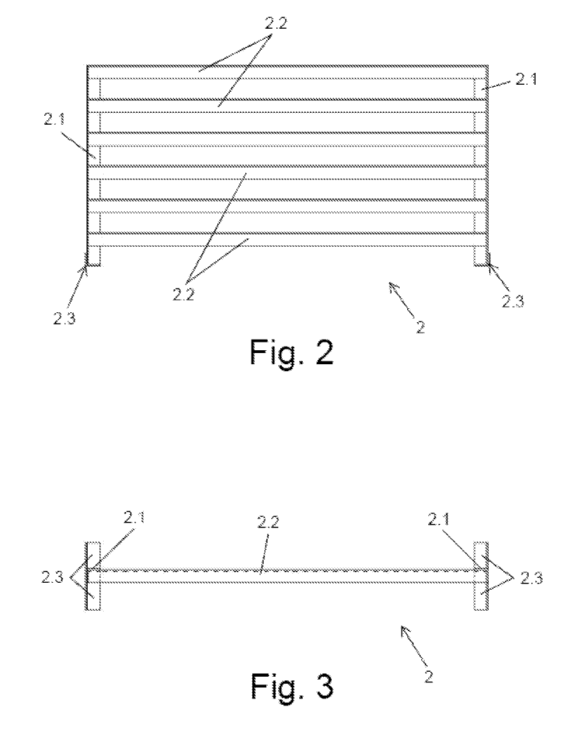

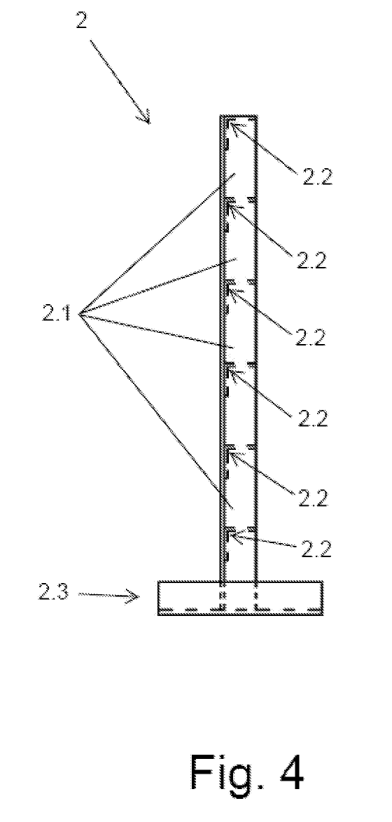

### DETAILED DESCRIPTION OF THE INVENTION

The invention relates to a spit roaster for foods comprising spits (1) and supports (2). The spit roaster for foods is easy to use in places such as fireplaces and barbecues and is suitable for roasting meat and fish, with beef steaks, ox steaks, lamb chops, kid goat meat, poultry, rabbits, chickens, hake, red sea bream, sea bass, and sea bream, standing out, for example. Due to its thickness, each of these foods requires different roasting heights in order to achieve optimum roasting.

The spits (1) comprised in the spit roaster for foods can be two or more in number. Said spits (1) are elements that are independent of the supports (2), so the free arrangement thereof according to different needs of roasting heights or the distance of said spits to one another is allowed.

The spits (1) are configured for holding foods to be roasted while roasting, either by the foods being directly arranged on the spits (1) or by the foods being arranged in a food support, such as a grill, or a fish pan, or fish-shaped grill, which can in turn be arranged on said spits (1).

The spits (1) preferably have a cross-section according to an angled, inverted V shape, i.e., a “Λ” shape. Therefore, in addition to being structurally reinforced to withstand a higher food weight and to withstand heat, the spits are supported on the supports (2) in a stable manner. Additionally and also preferably, the spits (1) have a longitudinal extension of between 40 cm and 90 cm, such that they provide flexibility when arranging the supports (2) spaced from one another, adapting to the roasting spaces, such as fireplaces, barbecues, etc.

The supports (2) used in the spit roaster for foods can be three in number in order to keep the spits (1) supported on said supports. Deformation of the spits (1) or the need to structurally reinforce said spits (1) when the spits (1) exceed a predetermined length is thereby prevented. When three supports (2) are used in the spit roaster for foods, the spits (1) can even have a longitudinal extension of between 150 cm and 200 cm.

Each of the supports (2) has two vertical profiles (2.1), horizontal profiles (2.2), and two feet (2.3), one for each of the two vertical profiles (2.1). The horizontal profiles (2.2) are arranged joining the two vertical profiles (2.1) to one another. Likewise, the horizontal profiles (2.2) are arranged spaced from one another, determining different roasting heights. Preferably, this spacing between the horizontal profiles (2.2) immediately contiguous to one another is about 5 cm.

The greater the length of the vertical profiles (2.1), the larger the number of horizontal profiles (2.2), and therefore the larger the number of roasting heights, there will be. Therefore, the vertical profiles (2.1) preferably have a longitudinal extension of 20 cm to 40 or 50 cm, and more preferably of 30 cm or 35 cm, whereas the horizontal profiles (2.2) preferably have a longitudinal extension of 20 cm to 80 or 90 cm, and more preferably of 40 cm to 80 or 90 cm, but in any case they can be made having the desired measurements.

These ranges of measurements allow sizing the spit roaster for foods such that it can be moved to a desired place for roasting the selected foods. Additionally, since the supports (2) are independent of one another, the distance of separation between them is also variable, providing flexibility to adapt to the different spaces in which they are placed, as well as to the foods to be roasted at the same time.

Each of the vertical profiles (2.1) preferably has at least two support feet (2.3) to keep the supports (2) according to an arrangement in accordance with a substantially vertical plane. One of the feet (2.3) is placed at each of the lower ends of each of the vertical profiles (2.1). Said feet (2.3) have a length of between 10 cm and 15 cm, and more preferably 12 cm, and are arranged perpendicular to the longitudinal arrangement of the horizontal profiles (2.2) to provide suitable vertical stability to the supports (2), although the arrangement may be the arrangement deemed the most appropriate.

The vertical profiles (2.1) and the horizontal profiles (2.2) preferably have, in addition to the feet (2.3), a right-angled, L-shaped cross-section, or more preferably a right-angled, L-shaped cross-section measuring 1×1 cm, 2×2 cm, 3×3 cm, etc. This geometry has the advantages of making the invention easy to obtain, in addition to making it easy to assemble and fix the horizontal profiles (2.2) and the feet (2.3) to the vertical profiles (2.1).

Additionally, the vertical profiles (2.1), the horizontal profiles (2.2), and the feet (2.3), as well as the spits (1), are made of carbon steel to withstand exposure to high temperatures during prolonged periods of time.

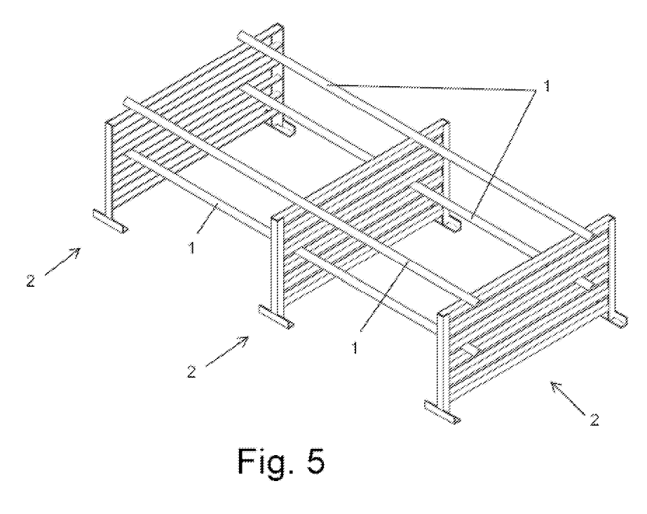

The spit roaster for foods can therefore be placed in the fireplace or barbecue before or after starting the fire. One of the supports (2) can be placed on the left and the other support (2) on the right, at a suitable distance according to the length of the spits (1) and amount or dimensions of the food to be roasted. Additionally, another one of the supports (2) can be placed according to said length of the spits (1), as can be seen in FIG. 5.

As described, the spits (1) can be placed, at least in twos, at different levels for roasting the foods according to roasting needs, with the levels being adapted to type of food and/or particular preferences of each consumer.

This spit roaster for foods thereby offers the advantages of not only being height adjustable, but also width and depth adjustable, clearly producing two or more models and being valid for all types of roasted foods from vegetables, thin slices of meat and fish, to slices of meat and fish a few centimeters thick.

This spit roaster for foods solves not only the need of many enthusiasts who appreciate good hot coal-roasted food, but also of an entire line of restaurants in which a spit roaster that can be easily installed at any time is suitable as a result of its versatility.

It must be pointed out that making the supports (2), which are formed by a rigid frame consisting of vertical profiles (2.1) and horizontal profiles (2.2), which rigid frame is inherently stable as it incorporates feet (2.3), allows each support (2) to be completely stable simply by arranging it on the surface of the apparatus or place where it will be installed.

In other words, the rigid frame defining each support (2) is formed by the two vertical profiles (2.1) which are arranged parallel to one another and joined by the horizontal profiles (2.2), wherein each vertical profile (2.1) has foot (2.3) at its lower end, arranged transverse to the vertical profile (2.1).

The supports (2) can therefore be arranged inside any fireplace, spit roaster, or on a floor, or even on the ground outside, and in all these options the supports will be perfectly positioned and completely stable by simply setting them up. The assembly of the spit roaster for foods object of the invention is therefore extremely simple since in the most common practical embodiment, i.e., the embodiment in which there are two supports (2), setting up the two supports (2) on their feet (2.3) will be sufficient for both supports to be arranged without further action and with full stability to receive the corresponding spits (1), the spit roaster now being assembled and ready to be used as such.

This feature is very important because the assembly simplicity of the supports (2) and the inherent stability thereof allows assembling the spit roaster inside a fireplace in which hot coals are already prepared and a great deal of heat is generated, requiring a quick and simple assembly of the spit roaster.

This very situation would arise when assembling the spit roaster outdoors, over the embers of a campfire, such that the spit roaster can be assembled when the hot coals have already been created, because the assembly speed of the supports (2) and their inherent stability allow performing this assembly, which would be impossible if complementary means for stabilizing the supports (2) which require time for installation had to be installed.

On the other hand, it is also important to take into account that with this solution simply moving the supports (2) farther away from or closer to one another is sufficient to enable adapting the spit roaster to the different inner dimensions of the fireplace or apparatus in which it will be installed, providing great versatility. Furthermore, other than making a simple cut at one of their ends to allow adapting them precisely to the measurement in each case, the spits (1) also allow a certain toying with dimension-wise, even toying with their more or less straight arrangement with respect to the horizontal profiles (2.2).

1. A spit roaster for foods, comprising:
spits;
at least two supports, each of the supports having:
two vertical profiles with feet for supporting the support;
horizontal profiles which are arranged:
joining the two vertical profiles to one another;
spaced from one another, determining different roasting heights;
where the spits can be arranged such that they are freely supported on the horizontal profiles of each of the supports, the spits being configured for holding foods.

2. The spit roaster for foods according to claim 1, wherein the spits have an angled, inverted V shape.

3. The spit roaster for foods according to claim 1, wherein the two vertical profiles and the horizontal profiles of each of the supports have an angled L shape.

4. The spit roaster for foods according to claim 1, wherein the supports are identical to one another.

5. The spit roaster for foods according to claim 1, wherein the spits are configured for foods to be held directly on them.

6. The spit roaster for foods according to claim 1, wherein the spits are configured for holding a food support on which the foods to be roasted can be arranged.

7. The spit roaster for foods according to claim 1, wherein the supports are three in number.

8. The spit roaster for foods according to claim 1, wherein by means of its feet, each support is inherently stable in its operative arrangement, such that the assembly of the spit roaster only requires the operative arrangement of the corresponding supports and the subsequent assembly of the respective spits thereon.

9. The spit roaster for foods according to claim 8, wherein the spits are only directly supported on the horizontal profiles which, along with the supports being inherently stable in their operative arrangement, allows varying the separation between the supports depending on the space available in the apparatus or site of installation.
